(19) United States
(12) Patent Application Publication
(10) Pub. No.: US 2015/0156332 A1
(43) Pub. Date: Jun. 4, 2015

(54) METHODS AND APPARATUS TO MONITOR USAGE OF MOBILE DEVICES

(71) Applicant: The Nielsen Company (US), LLC, Schaumburg, IL (US)

(72) Inventor: Anil Kandregula, Richardson, TX (US)

(21) Appl. No.: 14/621,010

(22) Filed: Feb. 12, 2015

Related U.S. Application Data
(63) Continuation of application No. 13/706,244, filed on Dec. 5, 2012.

(51) Int. Cl. H04M 15/00; G06Q 50/00; G06Q 30/02; H04W 24/08

(52) U.S. Cl. CPC H04M 15/58; H04W 24/08; G06Q 50/01; G06Q 30/0201

(57) ABSTRACT

Methods and apparatus are disclosed to identify usage of mobile devices are disclosed. An example method includes processing an image received from a mobile device of a panelist to identify text within the image, the image representing a display of the mobile device. A first interface displayed by the mobile device is identified based on the identified text. The panelist associated with the mobile device is credited as having viewed the identified interface.

### RELATED APPLICATION

This patent arises from a continuation of U.S. patent application Ser. No. 13/706,244, which was filed on Dec. 5, 2012, and is hereby incorporated herein by reference in its entirety.

### FIELD OF THE DISCLOSURE

This disclosure relates generally to audience measurement, and, more particularly, to methods and apparatus to monitor usage of mobile devices.

### BACKGROUND

In recent years, methods of accessing Internet content have evolved. For example, Internet content was formerly primarily accessed via computer systems such as desktop and laptop computers. Recently, handheld mobile devices (e.g., smartphones) have been introduced that allow users to request and view Internet content. Because of the closed nature and/or limited processing power of mobile devices, the amount of information that can be identified concerning media (e.g., content and/or advertisements) displayed by the mobile device is limited.

### BRIEF DESCRIPTION OF THE DRAWINGS

FIG. 1 is a diagram of an example monitoring entity and an example on-device meter constructed in accordance with the teachings of this disclosure and shown in an example environment of use.

FIG. 2 is a block diagram of an example implementation of the example mobile device and the example on-device meter of FIG. 1.

FIG. 3 is a block diagram of an example implementation of the example monitoring data collection site of FIG. 1 that may be used to identify usage of the mobile device.

FIGS. 4-7 illustrate example screenshots that may be recognized to identify usage of the mobile device of FIG. 1.

FIG. 8 is an example data table that may be stored by the example on-device meter of FIGS. 1 and/or 2 and transmitted to the monitoring data collection site of FIGS. 1 and/or 3.

FIG. 9 is a flowchart representative of example machine-readable instructions that may be executed to implement the example on-device meter of FIGS. 1 and/or 2.

FIG. 10 is a flowchart representative of example machine-readable instructions that may be executed to implement the example monitoring data collection site of FIGS. 1 and/or 3.

FIG. 11 is a flowchart representative of example machine-readable instructions that may be executed to implement the example monitoring data collection site of FIGS. 1 and/or 3.

FIG. 12 is a block diagram of an example processor platform that may execute, for example, the machine-readable instructions of FIGS. 9, 10, and/or 11 to implement the example monitoring data collection site of FIGS. 1 and/or 3, and/or the example on-device meter of FIGS. 1 and/or 2.

### DETAILED DESCRIPTION

Audience measurement companies, advertisers, and monitoring entities desire to gain knowledge on how users interact with their handheld mobile devices such as cellular phones, smartphones, and/or tablets. For example, audience measurement companies want to monitor Internet traffic to and/or from the handheld mobile devices to, among other things, monitor exposure to media (e.g., content and/or advertisements, determine advertisement effectiveness, determine user behavior, identify purchasing behavior associated with various demographics, determine media popularity, etc. Examples disclosed herein implement panelist-based systems to monitor interaction with and/or usage of mobile devices.

Panelist based systems disclosed herein enlist users (i.e., panelists) who have agreed to participate in a study. In such panelist systems, demographic information is obtained from the user when, for example, the user joins and/or registers for the panel. The demographic information may be obtained from the user, for example, via a telephone interview, by having the user complete a survey (e.g., an online survey), etc. The registration process may be conducted by the audience measurement entity and/or by a third party recruitment service. In examples disclosed herein, the panelist is instructed to install an on-device meter onto their mobile device (e.g., a cellular phone, a personal digital assistant, a tablet such as an iPad, etc.) In examples disclosed herein, the on-device meter monitors usage of the mobile device by capturing images representing media (e.g., content and/or advertisements) that is displayed by the mobile device. Using a panelist based system enables association of demographic information with a particular mobile device and, thus, with media displayed and/or accessed on the particular mobile device, enables identification of a location where the mobile device was when particular media was displayed, etc.

Operating systems used on mobile devices are typically closed platforms. That is, the operating systems provide a limited set of functions that applications executed by the mobile device can access via, for example, an Application Programming Interface (API). In contrast with desktop computing systems, the functions provided by such APIs typically do not allow for detailed monitoring of user interactions with applications by a monitoring application. For example, if a user is using a first application (e.g., a browser application, a social media application, etc.), monitoring the first application using a known second application (e.g. an on-device meter) is difficult, such that the second application is not able to capture details regarding how the user interacts with the first application. For example, if the user selects a link within the first application (e.g., to transition from one interface within the application to another), the known second application is not informed of the interaction. Accordingly, the second application cannot capture browsing activity (e.g., URLs that are visited by the user, durations of time that the user spent on a particular webpage, etc.).

In examples disclosed herein, and on-device meter is provided that is able to overcome the deficiencies of the known second application discussed above. In some examples, the API provided by the operating system of the mobile device enables the on-device meter to identify which application is in the foreground (e.g., which application is displayed to the user, etc.). Further, in some examples the API provides capability for the on-device meter to capture screenshots representing the display of the mobile device. Combining these two functions, example on-device meters disclosed herein detect when an application of interest is within the foreground of the mobile device display, and periodically takes screenshots that are uploaded to a monitoring data collection site for analysis. The screenshots are saved to the mobile device by some such example on-device meters. In some examples, additional data such as, for example, the location of the mobile device, a timestamp, a user identifier, an identifier of the application in the foreground, etc. are saved in association with the screenshot.

The screenshots and/or the additional data captured by the on-device meter of some examples disclosed herein are transmitted to a monitoring data collection site. The monitoring data collection site of some examples disclosed herein post-processes the screenshots and the additional data associated with those screenshots. In some examples, the monitoring data collection site performs optical character recognition (OCR) on the screenshots to identify items displayed by the mobile device. OCR is used to identify text (e.g., letters, numbers, etc.) that is contained within an image (e.g., a screenshot). The identified text can then be used to determine what was displayed by the mobile device such as, for example, a webpage, an advertisement, a status message, etc. In some examples, the identified text can be parsed to determine whether the identified text matches a pattern of a URL. If, for example, the identified text matches a pattern of URL, the user associated with the mobile device (e.g., the panelist) may be credited as having viewed the webpage located at the URL. In some examples, the identified text may identify a portion of a URL (e.g., a domain name). In some such examples, the user may be credited with having viewed the webpage identified by the partial URL (e.g., rather than a particular webpage defined by a complete URL).

In some examples, the monitoring data collection site uses image processing to identify activities of the user of the mobile device. For example, image processing may be used to identify advertisements displayed via the mobile device, to identify site specific images displayed via the mobile device (e.g., to identify whether a particular website was displayed), identify a location of the mobile device (e.g., based on identifiable features in images captured via a camera application of the mobile device), identify barcodes that have been within a field of view of a camera of the mobile device, identify the user of the mobile device (e.g., by taking a photograph of the user and performing image recognition on the photograph) etc.

In examples disclosed herein, the monitoring data collection site determines a duration that a user of the mobile device spent interacting with a particular application and/or webpage. For example, the monitoring data collection site may compare differences between timestamps of images taken while the same application and/or the same webpage was displayed by the mobile device. Identifying the duration that a user spent interacting with a particular application or webpage is important because it enables accurate identification of usage of the mobile device.

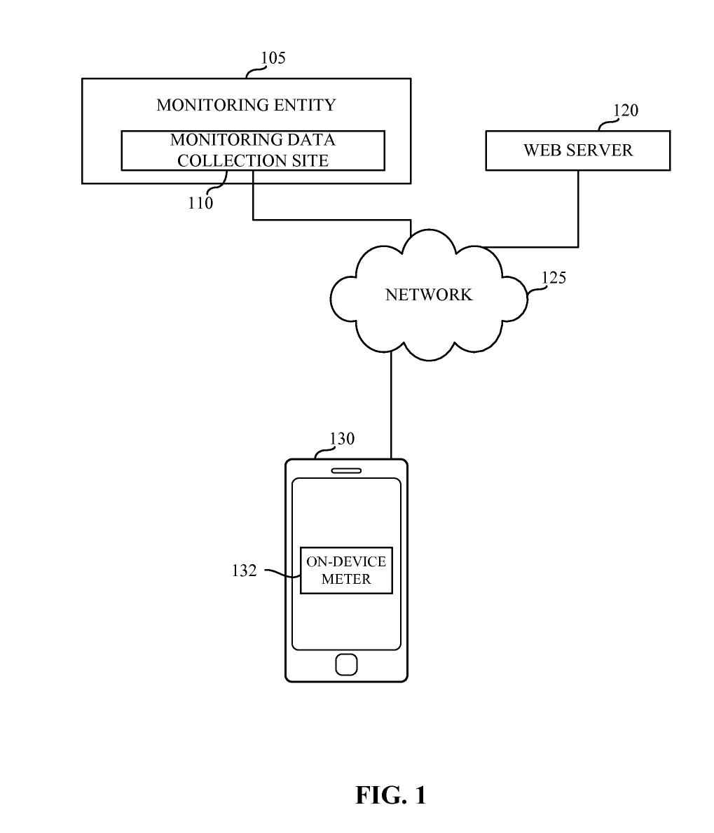

FIG. 1 is a diagram of an example system to monitor usage of mobile devices within an example environment of use. The example system includes a monitoring data collection site 110 operated by a monitoring entity 105 and an on-device meter 132. The example system of FIG. 1 shows an example environment of use including a Web server 120, a network 125, and a mobile device 130. In the illustrated example, the monitoring data collection site 110 is hosted by the monitoring entity 105, and the web server 120 is hosted by a third party. In the illustrated example, the on-device meter 132 is executed by the mobile device 130 and is provided by the monitoring entity 105. In the illustrated example, the mobile device 130 is operated by a user and may be referred to as “a user device.”

The example monitoring entity 105 of the illustrated example of FIG. 1 is an entity that monitors and/or reports exposure to media, advertisements and/or other types of media such as The Nielsen Company (US), LLC. In the illustrated example, the monitoring entity 105 is a neutral third party that does not provide content and/or advertisements to end users. This un-involvement with content/advertisement delivery ensures the neutral status of the monitoring entity 105 and, thus, enhances the trusted nature of the data it collects. In the illustrated example, the monitoring entity 105 operates and/or hosts the monitoring data collection site 110. The example monitoring data collection site 110 of the illustrated example is a server and/or database that collects and/or receives information related to the usage of mobile devices. In the illustrated example, the monitoring data collection site 110 receives information via the network 125 from multiple on-device meters 132 monitoring a respective plurality of mobile devices 130. However, the monitoring data collection site 110 may receive data in any additional and/or alternative fashion.

The web server 120 of the illustrated example of FIG. 1 provides information (e.g., advertisements, content, etc.) to the mobile device 130 via the network 125. In some examples, the information provided to the mobile device is returned in response to a request (e.g., an HTTP request) from the mobile device. Internet based requests are typically user-driven (i.e., they are performed directly and/or indirectly at the request of the user) and usually result in the display of the requested information to the user.

The example network 125 of the illustrated example of FIG. 1 is the Internet. However, any other network could additionally or alternatively be used. For example, some or all of the network 125 may be a company's intranet network, a personal (e.g., home) network, etc. Although the network 125 of the illustrated example operates based on the HTTP and IP protocols, the network 125 may additionally or alternatively use any other protocol to enable communication between devices on the network.

The example mobile device 130 of the illustrated example of FIG. 1 is a smartphone (e.g., an Apple® iPhone®, HTC Sensation, Blackberry Bold, etc.). However, any other type of phone and/or other device may additionally or alternatively be used such as, for example, a tablet (e.g., an Apple® iPad™, a Motorola™ Xoom™, a Blackberry Playbook, etc.), a laptop computer, a desktop computer, a camera, etc. In the illustrated example, the mobile device 130 is owned, leased, and/or otherwise belongs to a respective panelist and/or user. The monitoring entity 105 of the illustrated example does not provide the mobile device 130 to the panelist and/or user. In other examples, panelists are provided with a mobile device 130 to participate in the panel. In the illustrated example, the mobile device 130 is used to display information (e.g., content, advertisements, web pages, images, videos, interfaces, etc.) to the user (e.g., a panelist).

The on-device meter 132 of the illustrated example of FIG. 1 is software provided to the mobile device 130 by, for example, the monitoring entity 105 when or after, for example, a panelist associated with the mobile device 130 agrees to be monitored. See, for example, Wright et al., U.S. Pat. No. 7,587,732, which is hereby incorporated by reference in its entirety for an example manner of providing on-device meter functionality to a mobile device such as a cellular phone. In the example of FIG. 1, the on-device meter 132 collects monitoring information such as screenshots, user-browser interaction, user-application interaction, device status, user selection, user input, URL information, location information, application execution information, image information (e.g., metadata), etc. and stores the monitoring information in a memory of the mobile device 130. Periodically and/or aperiodically, the on-device meter 132 of the illustrated example transmits the monitoring information to the monitoring data collection site 110. In other examples, the collected monitoring information is streamed continuously and/or substantially continuously to the collection site 110. In the illustrated example, the on-device meter 132 may modify configuration settings of the mobile device 130 such as, for example, proxy settings, VPN settings, camera settings, etc. in order to enable access to the camera and/or images captured by the camera, enable communication of monitoring information to the monitoring entity 105, etc.

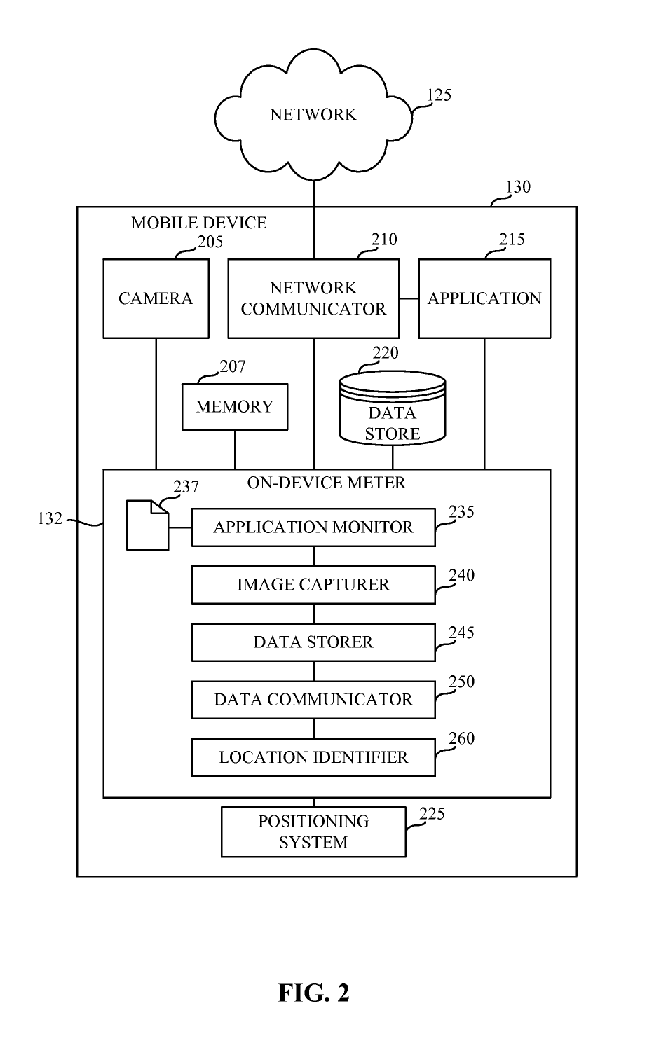

FIG. 2 is a block diagram of an example implementation of the example mobile device 130 of FIG. 1. The example mobile device of FIG. 2 includes an on-device meter 132 that may be used to identify usage of the mobile device 130. The mobile device 130 of the illustrated example further includes a camera 205, a memory 207, a network communicator 210, an application 215, a data store 220, and a positioning system 225.

The camera 205 of the illustrated example of FIG. 2 is a camera capable of taking images of the surroundings of the mobile device 130. In some examples, images taken by the camera 205 are stored in the memory 207 of the mobile device 130. In the illustrated example, the camera 205 is a charge-coupled device (CCD) camera. However, any other past, present, and/or future type and/or number of imaging device(s) may additionally or alternatively be used. In some examples, the camera 205 may be used to scan barcodes (e.g., a quick response (QR) code) when the user of the mobile device 130 aligns the mobile device 130 such that the QR code to be scanned is within a field of view of the camera 205.

The memory 207 of the illustrated example of FIG. 2 may be implemented by any device for storing data such as, for example, flash memory, magnetic media, optical media, etc. Furthermore, the data stored in the memory 207 may be in any data format such as, for example, binary data, comma delimited data, tab delimited data, structured query language (SQL) structures, etc.

The network communicator 210 of the illustrated example of FIG. 2 is implemented by a cellular communicator, to allow the mobile device 130 to communicate with a cellular network (e.g., the network 125). However, additionally or alternatively, the network communicator 210 may be implemented by any other type(s) of network interface such as, for example, an Ethernet interface, a Wi-Fi interface, a Bluetooth Interface, etc.

The application 215 of the illustrated example of FIG. 2 is implemented by a browser capable of displaying websites and/or other Internet media (e.g., product information, advertisements, videos, images, etc.) via the mobile device 130. In some examples, the application 215 is a social media application (e.g., Facebook, Instagram, Twitter, LinkedIn, Google+, etc.). In the illustrated example, the application 215 is implemented as an Android® browser. However, any other browser may additionally or alternatively be used such as, for example, Opera®, Dolphin®, Safari®, etc. Furthermore, browsers that are traditionally associated with use on a desktop and/or laptop computer may additionally and/or alternatively be used such as, for example, Google® Chrome®, Microsoft® Internet Explorer®, and/or Mozilla Firefox®.

The example data store 220 of the illustrated example of FIG. 2 may be implemented by any storage device for storing data such as, for example, flash memory, magnetic media, optical media, etc. Furthermore, the data stored in the data store 220 may be in any data format such as, for example, binary data, comma delimited data, tab delimited data, structured query language (SQL) structures, etc. While in the illustrated example the data store 220 is illustrated as a single database, the data store 220 may be implemented by any number and/or type(s) of databases.

The positioning system 225 of the illustrated example of FIG. 2 is implemented by a global positioning system (GPS). The positioning system 225 enables identification of the location of the mobile device 130. In some examples, the positioning system 225 determines the location based on signals received from satellites representative of the positions of the satellites in relation to the location of the mobile device. However in some other examples, the positioning system 225 determines location based on positions of cellular radio towers in relation to the location of mobile device. However, any other past, present, and/or future method for determining the location of the mobile device 130 (e.g., cellular tower triangulation) may additionally or alternatively be used.

The on-device meter 132 (ODM) of the illustrated example is implemented by a processor executing instructions but it could alternatively be implemented by an application specific integrated circuit(s) (ASIC(s)), programmable logic device(s) (PLD(s)) and/or field programmable logic device(s) (FPLD(s)), and/or other analog and/or digital circuitry. In the illustrated example, the ODM 132 includes an application monitor 235, an image capturer 240, a data storer 245, a data communicator 250, and a location identifier 260.

The example application monitor 235 of the illustrated example of FIG. 2 is implemented by a processor executing instructions, but it could alternatively be implemented by an ASIC, a PLD, or other analog and/or digital circuitry. In the illustrated example, the application monitor 235 monitors which application is within the foreground of the display of the mobile device 130. To this end, the application monitor 235 periodically queries an API of the mobile device 130 and receives an identifier of the application within the foreground. However, in some examples, the application monitor 235 is alerted by the API of the mobile device 130 when the application within the foreground of the display of the mobile device 130 is changed. The application monitor 235 compares the identifier of the application in the foreground to a list of applications of interest 237. If the application in the foreground is found within the list of applications of interest, the example application monitor 235 triggers the example image capturer 240 to capture a screenshot. If the application in the foreground is not found within the list of applications of interest 237, no screenshot is captured. The list of applications of interest 237 is stored in the data store 220. In the illustrated example, the list of applications of interest 237 is formatted as a comma separated value (CSV) file. However, any other format may additionally or alternatively be used. In the illustrated example, the list of application of interest 237 contains identifiers and/or other identifying information specifying applications that may be executed by the mobile device such as, for example, browsers, social media applications, streaming media applications, barcode scanning applications, news reader applications, music applications, camera applications, etc.

In the illustrated example, the list of applications of interest 237 is transmitted to the mobile device upon installation of the on-device meter 132. However, the list of applications of interest 237 may be periodically and/or a-periodically updated. For example, the on-device meter 132 may request an updated list of applications of interest 237 for the monitoring data collection site 110. Alternatively, the monitoring data collection site 110 may transmit a notification to the on-device meter 132 that an updated list of applications of interest 237 is available.

The example image capturer 240 of the illustrated example of FIG. 2 is implemented by a processor executing instructions, but it could alternatively be implemented by an ASIC, a PLD, or other analog and/or digital circuitry. In the illustrated example, the image capturer 240 is triggered by the application monitor 235 when the application monitor 235 identifies that an application of interest is in the foreground of the display. Other criteria such as, for example, how long a particular application of interest is in the foreground of the display may additionally or alternatively be used to trigger the image capturer 240 to capture a screenshot. In the illustrated example, the image capturer 240 captures screenshots representing the display of the mobile device 130. In the illustrated example, the screenshots are saved to the data store 220. However, in some examples the screenshots may be immediately transmitted to the monitoring data collection site 110. In the illustrated example, the screenshots are saved as a bitmap image (bmp). However, these screenshots may be saved in any other image format such as for example a Joint Photographic Experts Group (JPEG) format, a Tagged Image File Format (TIFF), a Portable Network Graphics (PNG) format, etc.

The example data storer 245 of the illustrated example of FIG. 2 is implemented by a processor executing instructions, but it could alternatively be implemented by an ASIC, a PLD, and/or other analog and/or digital circuitry. In the illustrated example, the example data storer 245 stores an identifier of the application in use at the time an image is captured and/or a source of the captured image. The example data storer 245 of FIG. 2 stores the captured image in the data store 245. In some examples, the example data storer 245 stores additional information in the data store 245 in association with the identifier and/or the image. For example, the example data storer 245 of FIG. 2 stores a location of the mobile device, a panelist identifier, and/or a timestamp.

The data communicator 250 of the illustrated example of FIG. 2 is implemented by an Ethernet driver that interfaces with the network communicator 210. In the illustrated example, the data communicator 250 transmits data stored in the data store 220 to the monitoring data collection site 110 via, for example, the Internet. While in the illustrated example, the data communicator 250 is an Ethernet driver, any other type(s) of interface may additionally or alternatively be used. While in the illustrated example a single data communicator 250 is shown, any number and/or type(s) of data communicators may additionally or alternatively be used.

The example location identifier 260 of the illustrated example of FIG. 2 is implemented by a processor executing instructions, but it could alternatively be implemented by an ASIC, a PLD, or other analog and/or digital circuitry. In the illustrated example, the location identifier 260 interfaces with the positioning system 225 of the mobile device 130. Because the mobile device 130 of the illustrated example is portable, the panelist may interact with the mobile device 130 at any location. Identifying the location where an interaction occurs enables the monitoring entity 105 to identify if there was an impetus for a particular interaction (e.g., the panelist interacted with their mobile device in response to seeing a billboard that was located near the location of the interaction, etc.). Such location information may be important because it may indicate, for example, that users are more likely perform certain types of interactions (e.g., use social media applications, read news articles, etc.) at particular locations (e.g., at work, at home, while traveling, etc.).

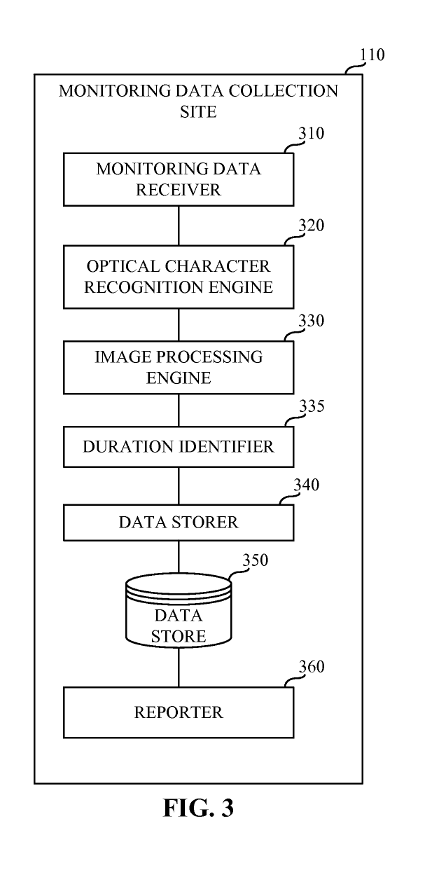

FIG. 3 is a block diagram of an example implementation of the example monitoring data collection site 110 of FIG. 1. The example monitoring data collection site 110 of the illustrated example of FIG. 3 includes a monitoring data receiver 310, an optical character recognition engine 320, an image processing engine 330, a duration identifier 335, a data storer 340, a data store 350, and a reporter 360.

The monitoring data receiver 310 of the illustrated example is implemented by a processor executing instructions, but it could alternatively be implemented by an ASIC, a PLD, and/or other analog and/or digital circuitry. Continuously, periodically, and/or aperiodically, the on-device meter 132 of the mobile device 130 transmits monitoring information (e.g., screenshots and/or additional data associated with the screenshots) to the monitoring data collection site 110. The monitoring data receiver 310 receives the monitoring information from the on-device meter 132. In some examples, the monitoring information is transmitted via, for example, the Internet. However, in some examples, the monitoring information is physically transported (e.g., via a storage device such as a flash drive, magnetic storage media, optical storage media, etc.) to a location of the monitoring data collection site 110. Typically, the monitoring data collection site 110 will receive data from many user devices.

The Optical Character Recognition (OCR) engine 320 of the illustrated example is implemented by a processor executing instructions, but it could alternatively be implemented by an ASIC, a PLD, and/or other analog and/or digital circuitry. In the illustrated example, the OCR engine 320 scans the screenshots received from the on-device meter 132 and attempts to identify text within the screenshots. In the illustrated example, the OCR engine 320 is implemented using an open source text recognition system such as for example, Tesseract, cuneiform, etc. However, in some examples the OCR engine 320 is implemented using a proprietary and/or closed source text recognition system such as, for example, the ABBYY® OCR engine. The OCR engine 320 of the illustrated example creates an output file associated with the scanned screenshot. In the illustrated example, the output file is implemented using the Hypertext Markup Language (HTML) OCR format (hOCR). However any other format may additionally or alternatively be used. The output file indicates text that was identified within the image and/or the position of the text identified within the image. Identifying the location of the text within the image is useful because, for example, particular fields within different applications may be known to exist in particular locations. For example, the URL bar within most browser applications is located near the top of the screen. Identifying text within the URL bar may more accurately identify a URL of a webpage that is displayed by the mobile device.

The image processing engine 330 of the illustrated example of FIG. 3 is implemented by a processor executing instructions, but it could alternatively be implemented by an ASIC, a PLD, and/or other analog and/or digital circuitry. In the illustrated example, the image processing engine 330 processes the screenshots received from the on-device meter 132 and attempts to identify patterns and/or shapes (e.g., icons, logos, barcodes, landmarks, etc.) within the screenshots. In the illustrated example, the image processing engine 330 compares the identified patterns and/or shapes to known patterns and/or shapes to identify, for example, a particular interface within an application (e.g., a status interface within a social media application), identify whether a particular website is being displayed, identify advertisements displayed by the mobile device, etc. In some examples, the image processing engine 330 identifies site-identifying images (e.g., a logo) that may be used to identify a displayed website in the absence of identifiable text (e.g., while the URL bar is not displayed).

In some examples, the screenshots may represent images captured by the camera 205 of the mobile device 130. The screenshots representing images captured by the camera 205 may be processed to identify landmarks and/or features within the screenshots that indicate where the mobile device is and/or has been. For example, referring to FIG. 7, a landmark such as the Eiffel tower in Paris, France may be identified within a photo collected via a camera application, thereby indicating that the Eiffel tower was within a field of view of the camera of the mobile device 130 and, accordingly, that the mobile device was likely in Paris, France. In some examples, an advertisement may have been within the field of view of the camera 205 and, accordingly, the panelist may be credited as having seen the advertisement. In some examples, a barcode (e.g., a QR code) may be identified as having been within the field of view of the camera 205. The image processing engine 330 identifies a product associated with the barcode and credits the panelist with having viewed the product.

The duration identifier 335 of the illustrated example of FIG. 3 is implemented by a processor executing instructions, but it could alternatively be implemented by an ASIC, a PLD, and/or other analog and/or digital circuitry. In the illustrated example, the example duration identifier 335 identifies a duration of use of an application, a website, an interface within an application, etc. Furthermore, the duration identifier 335 of the illustrated example compares timestamps of the records associated with the screenshots along with application identifying information and/or website identifying information to determine a duration of display of different applications and/or web sites. The panelist may then be credited with having viewed and/or interacted with the application and/or website for the identified amount of time.

The data storer 340 of the illustrated example of FIG. 3 is implemented by a processor executing instructions, but it could alternatively be implemented by an ASIC, a PLD, and/or other analog and/or digital circuitry. In the illustrated example, the example data storer 330 stores monitoring information received via monitoring data receiver 310, and/or recognition information generated by the OCR engine 320, the image processing engine 330, and/or the duration identifier 335.

The example data store 350 of the illustrated example of FIG. 3 may be implemented by any storage device and/or storage disc for storing data such as, for example, flash memory, magnetic media, optical media, etc. Furthermore, the data stored in the data store 350 may be in any data format such as, for example, binary data, comma delimited data, tab delimited data, structured query language (SQL) structures, etc. While in the illustrated example the data store 350 is illustrated as a single database, the data store 350 may be implemented by any number and/or type(s) of databases.

The example reporter 360 of the illustrated example of FIG. 3 is implemented by a processor executing instructions, but it could alternatively be implemented by an ASIC, a PLD, and/or other analog and/or digital circuitry. In the illustrated example, the reporter 360 generates reports based on the received monitoring information. The reports may identify different aspects about user interaction with mobile devices such as, for example, an amount of time users spend performing a particular action within an application (e.g., reading social media posts, reading a blog, etc.), whether users are more likely to interact with social media applications in a particular location (e.g., at home, at work, etc.), etc.

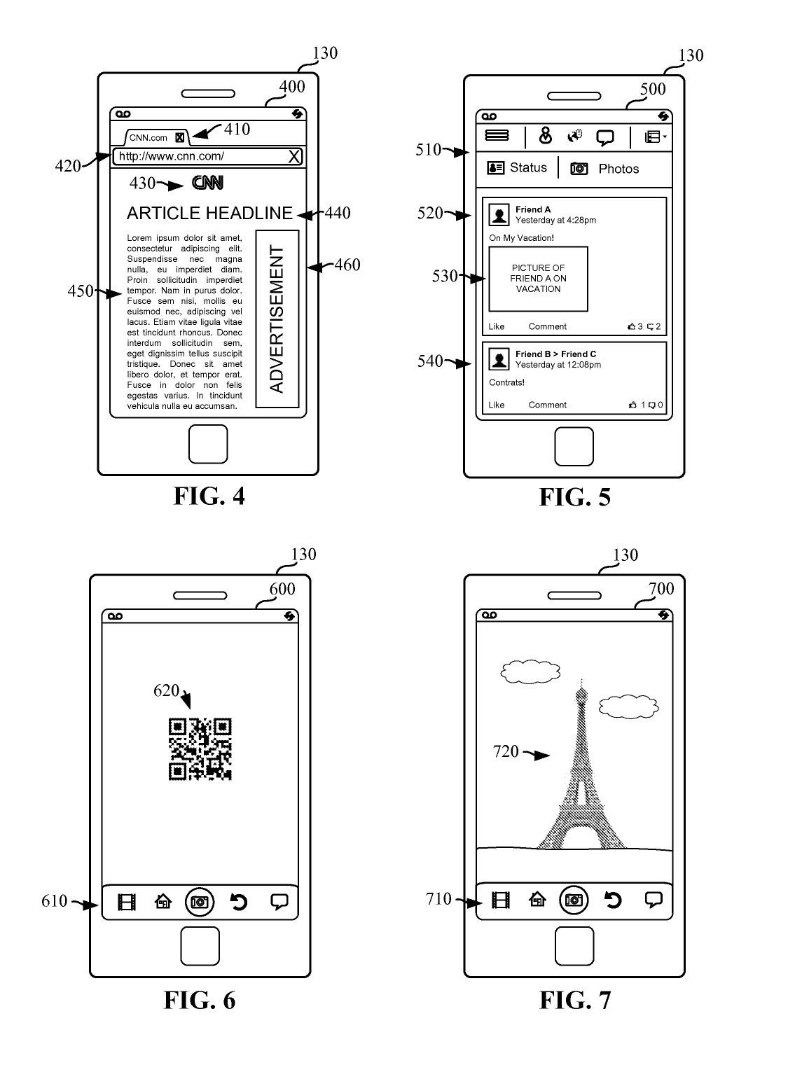

FIGS. 4, 5, 6, and/or 7 are block diagrams illustrating example interfaces (e.g., screenshots) that may identify usage of the mobile device 130. Each of FIGS. 4, 5, 6, and/or 7 show screenshots 400, 500, 600, 700 of the display of the mobile device 130. In the illustrated examples of FIGS. 4, 5, 6, and/or 7, the body (e.g., frame, housing, etc.) of the mobile device 130 is shown for clarity. However, the screenshots 400, 500, 600, 700 typically only represent items that are displayed by the mobile device and do not include the body of the mobile device 130.

The illustrated example of FIG. 4 includes an example screenshot 400. The example screenshot 400 represents activity of the mobile device 130 while displaying a browser application (e.g., Opera®, Dolphin®, Safari®, etc.). There are a number of objects displayed in the example screenshot 400. For example, a browser tab 410, a universal resource locator (URL) bar 420, an image 430 identifying a site displayed by the browser application, a headline of an article 440, text of an article 450, and an advertisement 460 are displayed by the browser application. However, other objects may be additionally or alternatively be displayed. When the image processing engine 330 and/or the OCR engine 320 process the screenshot 400, the image processing engine 330 and/or the OCR engine 320 detect that the browser application is displayed in the screenshot 400. The image processing engine 330 and/or the OCR engine 320 identify that the browser application is displayed by, for example, identifying a shape of the browser tab 410, the presence of a URL bar, etc. Furthermore, the image processing engine 330 and/or the OCR engine 320 may identify the website displayed by the browser application by, for example, identifying the text of the URL bar 420, identifying the image 430 that identifies a particular website is displayed. In some examples, the image processing engine 330 and/or the OCR engine 320 identifies the headline of the article 440 and/or the text of the article 450 and performs an Internet search to identify a webpage and/or website that was captured in the screenshot 400. In some examples, the image processing engine 330 and/or the OCR engine 320 identifies the advertisement 460 such that a record of which advertisements were displayed by the mobile device 130 can be created.

FIG. 5 illustrates an example screenshot 500. The example screenshot 500 represents activity of the mobile device 130 while displaying a social media application (e.g., Facebook, Twitter, etc.). The example screenshot 500 includes a toolbar 510, a status message of a first friend 520, an image 530, and a message from a second friend 540. However, any other objects may be displayed such as, for example, advertisements, invitations, photos, etc. The image processing engine 330 and/or the OCR engine 320 of the monitoring data collection site 110 processes the example screenshot 500 to identify the social media application and/or to identify which interface within the social media application is displayed in the screenshot 500. Identifying an interface within the social media application may, in some examples, enable identification and/or classification of how users interact with the social media application. For example, interaction with the social media application may be identified and/or classified to establish how long users spend creating content (e.g., posting statuses, commenting on another's post, uploading images, etc.), how long users spend viewing content (e.g., reading posts and/or statuses, viewing images, etc.), etc. For example, it may be determined that the user spent ten minutes commenting on other's statuses using the social media application on a given day, while the same user also spend thirty minutes viewing other's statuses using the social media application on the same day. Such durations may be identified by comparing timestamps of screenshots and classifications of the screenshots against temporally sequential screenshots to identify a duration of a particular activity (e.g., creating content, viewing content, etc.)

In some examples, the image processing engine 330 and/or the OCR engine 320 process the example screenshot 500 to identify the toolbar 510. Identification of a particular toolbar may indicate that a particular social media application and/or a particular interface within the social media application is displayed. In some examples, the image processing engine 330 and/or the OCR engine 320 process the example screenshot 500 to identify status messages (e.g., the status message of the first friend 520, the message from the second friend 540), images (e.g., the image 530), etc. Identifying status messages and/or posts of friends of the panelist may enable identification of content and/or advertisements presented to the panelist. For example, if a friend of the panelist posts a link to a product, the product may be identified as having been displayed to the panelist. In some other examples, if a friend of the panelist posts an image (e.g., the image 530), the image may be identified to determine activities, interests, etc. of the friends of the panelist. For example, it may be identified that a friend of the panelist is interested in traveling by, for example, identifying text (e.g., words, phrases, etc.), and/or images associated with traveling. Identifying such an interest of the friend of the panelist may enable identification of the interests of the panelist.

FIG. 6 illustrates an example screenshot 600. The example screenshot 600 represents activity of the mobile device 130 while a camera application is displayed. The example screenshot 600 includes a camera toolbar 610 and a barcode 620. When the image processing engine 330 of the monitoring data collection site 110 processes the screenshot 600, the image processing engine 330 detects that a camera application was displayed when the screenshot was captured 600 because, for example, the camera toolbar 610 is identified. Furthermore, the image processing engine 330 decodes the barcode 620 and, in some examples, identifies a product associated with the barcode. For example, if a user were to scan the barcode 620 such as, for example, a universal product code (UPC) code using the mobile device 130, the image processing engine 330 identifies the product associated with the UPC code.

FIG. 7 illustrates an example 700. The example screenshot 700 represents activity of the mobile device 130 while a camera application is displayed. The example screenshot 700 includes a camera toolbar 710 and an image 720 including identifiable features. Similar as to what was described with respect to FIG. 6, when the image processing engine 330 of the monitoring data collection site 110 processes the screenshot 700, the image processing engine 330 detects that a camera application was displayed when the screenshot was captured 700 because, for example, the camera toolbar 710 is identified. Furthermore, the image processing engine 330 processes the image 720 to identify features within the image. In the illustrated example of FIG. 7, the image 720 includes a geographic landmark (i.e., the Eiffel tower) which, when identified, may indicate that the landmark was within a field of view of the camera 205 of the mobile device 130. With respect to FIG. 7, identifying the Eiffel tower may indicate that the mobile device 130 was located in Paris, France when the screenshot 700 was captured. However, any other type of feature such as, for example, faces, buildings, scenery, documents, advertisements, etc. may additionally and/or alternatively be identified.

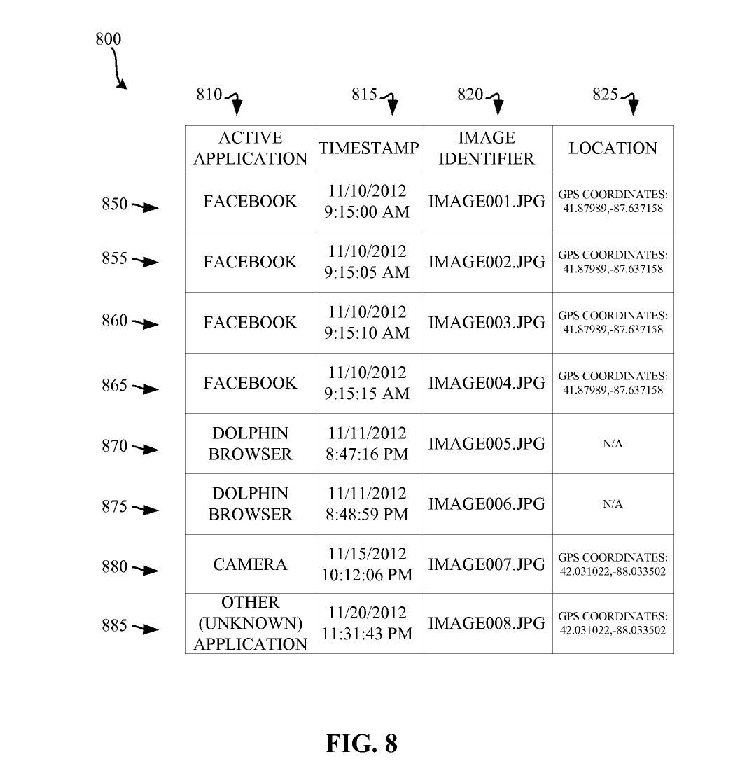

FIG. 8 illustrates an example data table 800 that may be stored by the example on-device meter 132 and transmitted to the example monitoring data collection site 110 of FIG. 1. The example data table 800 includes records 850, 855, 860, 865, 870, 875, 880, and 885 that represent data associated with screenshots (e.g., images) captured by the on-device meter 132. The example data table 800 identifies an application in use 810 when the image was captured, timestamps of when the image was captured 815, an identifier 820 of the image that was captured, and a location of the mobile device 825 when the image was captured.

The active application column 810 of the illustrated example of FIG. 8 represents an application that was active when the on-device meter 132 captured a screenshot. Identifying the application that was active when the screenshot was captured enables more accurate identification of objects within the image. For example, a browser application is likely to have a URL bar and/or a title bar including identifiable text near the top of the screenshot. In contrast, a camera application may be less likely to include identifiable text.

The timestamp column 815 of the illustrated example of FIG. 8 represents a time when the on-device meter 132 captured the screenshot. However, the timestamp column 815 may alternatively represent a time when the record of the screenshot was stored. Storing a timestamp (e.g., date and/or time) enables analysis of how long a user was using a particular application. For example, if consecutive records indicate that a user was continuously using the application for two minutes, the user may be credited with two minutes of continuous use of the application.

The image identifier column 820 of the illustrated example identifies the screenshot that was captured by the on-device meter 132. In the illustrated example, the screenshots are stored separately from the table 800 and the image identifier in the image identifier column 820 functions as a pointer to the image that was captured in association with the record (e.g., the row within the table 800). However, in some examples, the image may be directly included in the table. While in the illustrated example the image identifier represents a filename of the screenshot, any additional or alternative information may be used to identify the screenshot associated with the record such as, for example, a serial number, a hash value (e.g., a cyclical redundancy check (CRC), a Message-Digest version 5 (MD5) identifier, etc.), metadata, etc.

The location column 825 of the illustrated example of FIG. 8 represents location information at the time the screenshot was captured by the on-device meter 132. In the illustrated example, the location column 825 represents a location of the mobile device 130 using global positioning system (GPS) coordinates. However, any other information and/or any other format may additionally and/or alternatively be used such as, for example, a street address, etc.

While an example manner of implementing the example on-device meter 132 of FIG. 1 has been illustrated in FIG. 2 and an example manner of implementing the example monitoring data collection site 110 of FIG. 1 has been illustrated in FIG. 3, one or more of the elements, processes and/or devices illustrated in FIGS. 1, 2, and/or 3 may be combined, divided, re-arranged, omitted, eliminated and/or implemented in any other way. Further, the example application monitor 235, the example image capturer 240, the example data storer 245, the example data communicator 250, the example location identifier 260, and/or, more generally, the example on-device meter 132 of FIGS. 1 and/or 2, and/or the example monitoring data receiver 310, the example OCR engine 320, the example image processing engine 330, the example duration identifier 335, the example data storer 340, the example data store 350, the example reporter 360, and/or, more generally, the example monitoring data collection site 110 of FIGS. 1 and/or 3 may be implemented by hardware, software, firmware and/or any combination of hardware, software and/or firmware. Thus, for example, any of the example application monitor 235, the example image capturer 240, the example data storer 245, the example data communicator 250, the example location identifier 260, and/or, more generally, the example on-device meter 132 of FIGS. 1 and/or 2, and/or the example monitoring data receiver 310, the example OCR engine 320, the example image processing engine 330, the example duration identifier 335, the example data storer 340, the example data store 350, the example reporter 360, and/or, more generally, the example monitoring data collection site 110 of FIGS. 1 and/or 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example application monitor 235, the example image capturer 240, the example data storer 245, the example data communicator 250, the example location identifier 260, the example monitoring data receiver 310, the example OCR engine 320, the example image processing engine 330, the example duration identifier 335, the example data storer 340, the example data store 350, and/or the example reporter 360 are hereby expressly defined to include a tangible computer readable storage medium (e.g., a storage device or storage disc) such as a memory, DVD, CD, Blu-ray, etc. storing the software and/or firmware. Further still, the example on-device meter 132 of FIGS. 1 and/or 2, and/or the example monitoring data collection site 110 of FIGS. 1 and/or 3 may include one or more elements, processes and/or devices in addition to, or instead of, those illustrated in FIGS. 1, 2, and/or 3, and/or may include more than one of any or all of the illustrated elements, processes and devices.

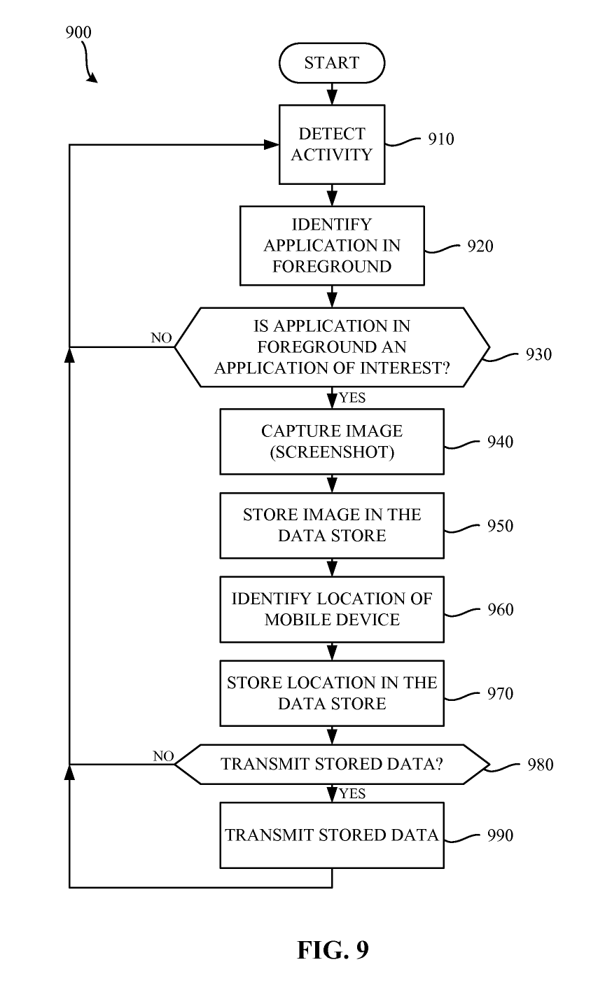

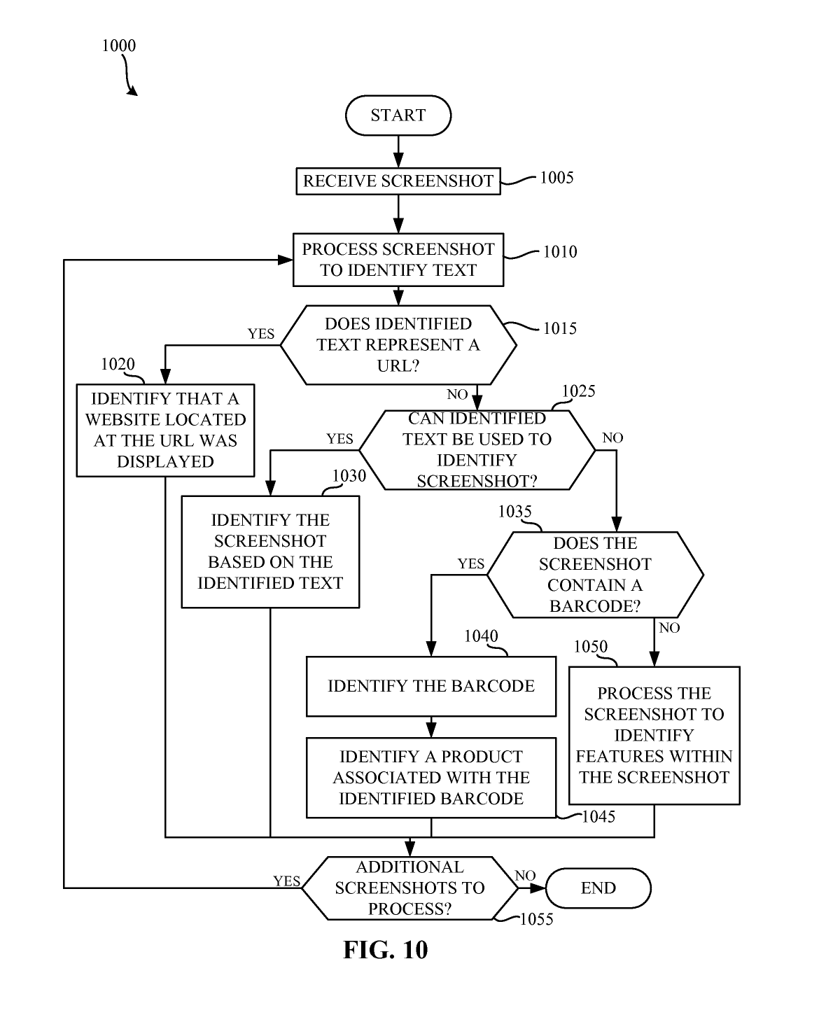

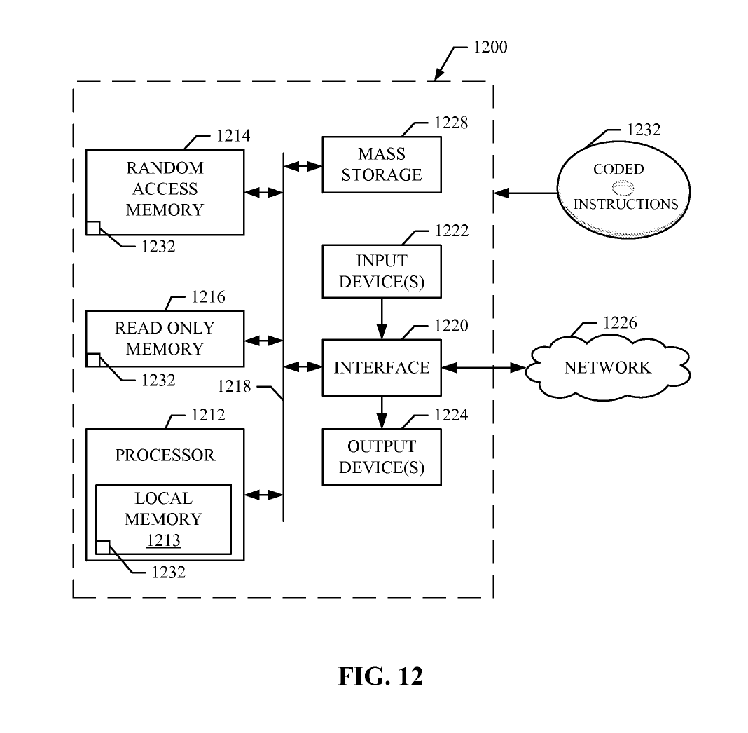

Flowcharts representative of example machine-readable instructions for implementing the example on-device meter 132 of FIGS. 1 and/or 2, and/or the example monitoring data collection site 110 of FIGS. 1 and/or 3 are shown in FIGS. 9, 10, and/or 11. In these examples, the machine-readable instructions comprise a program for execution by a physical hardware processor such as the processor 1212 shown in the example processor platform 1200 discussed below in connection with FIG. 12. A processor is sometimes referred to as a microprocessor or a central processing unit (CPU). The program may be embodied in software stored on a tangible computer-readable medium such as a CD-ROM, a floppy disk, a hard drive, a digital versatile disk (DVD), a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowcharts illustrated in FIGS. 9, 10, and/or 11, many other methods of implementing the example the example on-device meter 132 of FIGS. 1 and/or 2, and/or the example monitoring data collection site 110 of FIGS. 1 and/or 3 may alternatively be used. For example, the order of execution of the blocks may be changed, and/or some of the blocks described may be changed, eliminated, or combined.

As mentioned above, the example processes of FIGS. 9, 10, and/or 11 may be implemented using coded instructions (e.g., computer-readable instructions) stored on a tangible computer-readable storage medium such as a hard disk drive, a flash memory, a read-only memory (ROM), a compact disk (CD), a digital versatile disk (DVD), a cache, a random-access memory (RAM)) and/or any other storage device or disc in which information is stored for any duration (e.g., for extended time periods, permanently, brief instances, for temporarily buffering, and/or for caching of the information). As used herein, the term tangible computer-readable storage medium is expressly defined to include any type of computer-readable storage disc or storage device and to exclude propagating signals. Additionally or alternatively, the example processes of FIGS. 9, 10, and/or 11 may be implemented using coded instructions (e.g., computer-readable instructions) stored on a non-transitory computer-readable medium such as a hard disk drive, a flash memory, a read-only memory, a compact disk, a digital versatile disk, a cache, a random-access memory and/or any other storage medium in which information is stored for any duration (e.g., for extended time periods, permanently, brief instances, for temporarily buffering, and/or for caching of the information). As used herein, the term non-transitory computer-readable medium is expressly defined to include any type of computer-readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 9 is a flowchart 900 representative of example machine-readable instructions that may be executed to implement the example on-device meter 132 of FIGS. 1 and/or 2. The example process 900 begins when the application monitor 235 detects activity. (block 910). In the illustrated example, activity is detected when the display is active. In other words, activity is not detected when the display is off (e.g., the mobile device 130 is idle). An active display may be detected by, for example, querying (e.g., polling) an API of the mobile device 130 to retrieve a status of the display of the device. The application monitor 235 identifies the application in the foreground of the display of the mobile device 130. (block 920).

In the illustrated example, the application monitor 235 identifies the application in foreground of the display of the mobile device by querying (e.g., polling) an API of the mobile device 130. In response to the query, the application monitor 235 receives an identifier of the application in the foreground of the display of the mobile device 130 from the API. In the illustrated example, the identifier is an application name. However, in some examples, the identifier may be a process identifier that specifies a name of the process associated with the application.

In the illustrated example, the application monitor 235 attempts to detect activity once every five seconds. That is, once activity has been detected, the application monitor 235 will not attempt to detect activity for the next five seconds. However, any other delay threshold may additionally or alternatively be used such as, for example, one second, two seconds, ten seconds, thirty seconds, etc. In some examples, the delay threshold is only applied when activity is detected within the same application. In other words, the application monitor 235 will attempt to detect activity without waiting the delay threshold when the application in the foreground of the display of the mobile device is changed.

The example application monitor 235 compares the application identifier to a list of applications of interest 237. (block 930). In the illustrated example, the list of applications of interest 237 specifies applications that should be monitored by the on-device meter 132 (e.g., browsers, social media applications, etc.). The list of applications of interest 237 is provided by the monitoring data collection site 110. In some examples, the application monitor 235 periodically requests an updated list of applications of interest 237 from the monitoring data collection site 110. If the application in the foreground of the display of the mobile device is not found on the list of applications of interest, control returns to block 910 where the application monitor 235 attempts to detect activity of the mobile device 130 when the delay threshold has passed.

If the application in the foreground of the display of the mobile device is in the list of applications of interest, the image capturer 240 captures an image representing the display of the mobile device 130. (block 940). In the examples described herein, the images are referred to as screenshots. Example screenshots are shown in FIGS. 4, 5, 6, and/or 7. In the illustrated example, the screenshots are formatted as bitmap images. However, any other format may additionally or alternatively be used. In the illustrated example, the data storer 245 stores the captured image in the data store 220. (block 950).

The example location identifier 260 determines a location of the mobile device 130. (block 960). In the illustrated example, the location identifier 260 determines the location using a GPS system of the mobile device 130. However, in some examples, the location identifier 260 may additionally or alternatively use any other approach to determine the location such as, for example, using wireless networks (e.g., known locations of Wi-Fi networks, cellular triangulation, etc.). In some examples, determining the location of the mobile device 130 may not be possible (e.g., when no GPS satellites are available, etc.). In such examples, the location information may be omitted, and/or a record indicating that no location information was available may be stored in association with the record of the decoded information.

The example data storer 245 stores the location of the mobile device 130 in the data store 220 in association with the screenshot. (block 970). In the illustrated example, the data storer 245 stores the location data as part of additional data associated with the screenshot (e.g., a timestamp of when the screenshot was taken, the identifier of the application in the foreground of the display of the mobile device 130, etc.). In the illustrated example, the additional data is stored in a table (e.g., a table similar to the table of FIG. 8) that is separate from the screenshot. However, any other type(s) and/or format(s) of data structure for storing the additional data may additionally or alternatively be used. In some examples, the additional data is stored as part of the screenshot via, for example, a metadata tag. In some examples, the metadata tag is formatted using an exchangeable image file format (Exif). However, any other metadata format may additionally or alternatively be used.

The data communicator 250 then determines whether the screenshot and/or the additional data should be transmitted to the monitoring data collection site 110. (block 980). If the screenshot and/or the additional data should be transmitted (e.g., a timer to transmit the information has expired, a threshold amount of data has been stored, a specific time of day has occurred, a wireless connection is available, etc.), the data communicator 250 transmits the screenshot and/or the additional data to the monitoring data collection site 110 (block 990). Otherwise, the data communicator 250 does not transmit the screenshot and/or the additional data, and control returns to block 910. In the illustrated example, the screenshot and/or the additional data is transmitted whenever an Internet data connection is available. However, in some examples, the screenshot and/or the additional data may only be transmitted when an Internet connection via WiFi is available to reduce the amount of data that is transmitted via a cellular connection of the mobile device 130. In some examples, the data communicator 250 transmits the stored record in an aperiodic fashion. That is, the stored screenshots and/or additional data are transmitted once a threshold amount of screenshots are stored in the data store 220 of the mobile device 130. However, the data communicator 250 may transmit the stored record in any other fashion. For example, the data communicator 250 may transmit the stored records on a periodic basis (e.g., daily, hourly, weekly, etc.). In some examples, the data communicator 250 transmits the stored records once a threshold amount of data (e.g., 1 KB, 64 KB, 1 MB, etc.) is stored in the data store 220. However, any other threshold may additionally or alternatively be used to trigger data transmission, such as, for example, a threshold number of screenshots. Additionally or alternatively, the data communicator 250 may transmit the record(s) in response to an external event such as, for example, when a request for screenshots and/or additional data is received from the monitoring data collection site 110, when a wireless network is available, etc. In some examples, the periodic and aperiodic approaches may be used in combination.

In the above example, screenshots are collected whenever an application of interest is in the foreground of the display of the mobile device. However, other trigger events could be used to collect screenshots such as, for example, identifying when user input is received at the mobile device, identifying when the foreground application of the mobile device is changed, when a timer expires. Furthermore, such example triggers may be used in any combination.

FIG. 10 is a flowchart 1000 representative of example machine-readable instructions that may be executed to implement the example monitoring data collection site 110 of FIGS. 1 and/or 3. The example process begins when the monitoring data receiver 310 receives the screenshot(s) and/or the additional data from the on-device meter 132. (block 1005). The OCR engine 320 processes the screenshot to identify text within the screenshot. (block 1010). In the illustrated example, the OCR engine 320 generates a text file that represents text identified within the screenshot. The OCR engine 320 parses the text file for site-identifying and/or application-identifying text. In particular, the data storer 330 determines whether the identified text represents a URL (block 1015). If the text represents a URL, the data storer 330 records an identification of the website identified by the URL in association with the screenshot. (block 1020). If the text does not represent a URL, the data storer 330 parses the text file to determine whether the identified text can be used to identify what was displayed by the mobile device 130. (block 1025). For example, if the OCR engine 320 detects a headline of an article (e.g., similar to the article headline 440 of FIG. 4), a page title contained within a page title block (e.g., similar to the page title block 410 of FIG. 4), text displayed by the mobile device (e.g., the body of the article 450 of FIG. 4), etc., such identified text can be used to identify what was displayed by the mobile device. If it is possible to identify what was displayed, the data storer 330 identifies the displayed webpage based on the identified text. (block 1030). In the illustrated example, the data storer 330 performs an Internet search using the identified text to find a webpage that includes the identified text of the screenshot. However, any other approach to identifying a webpage and/or an application interface (e.g., a social media application interface, a music application interface, a video application interface, a game interface, etc.) may additionally or alternatively be used.

If the identified text cannot be used to identify the screenshot, the image processing engine 325 determines whether the screenshot contains a barcode. (block 1035). Identifying a barcode may identify if the user of the mobile device was shopping for and/or gathering details for a product associated with the barcode. If the screenshot contains a barcode, the image processing engine 325 identifies the barcode. (block 1040). The barcode is then used to identify a product associated with the identified barcode. The data storer 330 stores the identification of the product in association with the screenshot. (block 1045).

If the screenshot does not contain a barcode, the image processing engine 325 processes the screenshot to identify features within the screenshot. (block 1050). In the illustrated example, the image processing engine 325 identifies controls, shapes, colors, etc. to identify what was displayed by the mobile device 130. For example, if an icon representing a particular website (e.g., cnn.com) similar to the object 430 of FIG. 4 is identified, the image processing engine 325 records that the object 430 was displayed. See, for example, U.S. patent application Ser. No. 12/100,264, which is hereby incorporated by reference in its entirety for an example manner of identifying controls displayed as part of an interface. Also see, for example, U.S. patent application Ser. No. 12/240,756, which is hereby incorporated by reference in its entirety for an example manner of detecting webpage components. In some examples, the image processing engine 325 records that a website and/or application associated with the identified object was displayed. For example, if the image processing engine 325 identifies a menu bar such as, for example, the menu bar 510 of FIG. 5, the image processing engine 325 may record that an application (e.g., a social media application such as Facebook, Twitter, etc.) associated with the menu bar was displayed. In some examples, the image processing engine 325 processes the screenshot to identify geographic landmarks and/or indicia of a location of the mobile device 130. With reference to FIG. 7, a landmark 720 such as, for example, the Eiffel tower may be identified. The image processing engine 325 records that the mobile device was near the landmark 720.

The image processing engine 325 determines whether additional screenshots are to be processed (block 1055). If additional screenshots are to be processed, control proceeds to block 1010 where the OCR engine 320 processes the screenshot to identify text within the screenshot. If no additional screenshots are to be processed, the example process of FIG. 10 terminates.

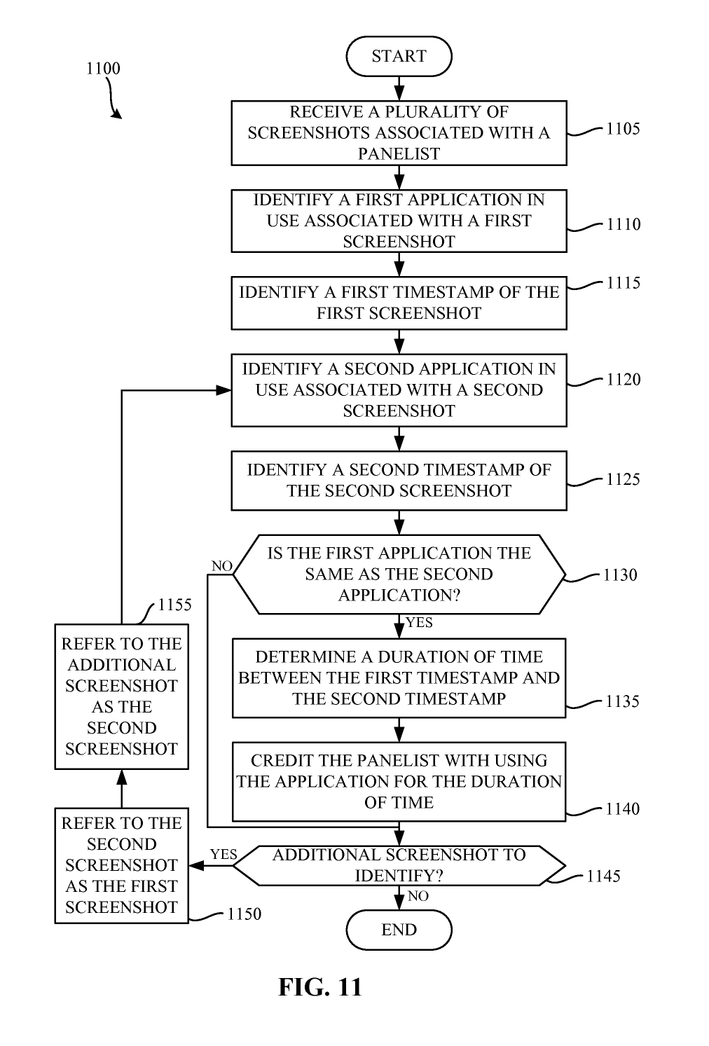

FIG. 11 is a flowchart 1100 representative of example machine-readable instructions that may be executed to implement the example monitoring data collection site 110 of FIGS. 1 and/or 3 to identify durations of time that an application was displayed by the mobile device 130. While the illustrated example of FIG. 11 is described with respect to identifying the duration of time that an application was displayed, the example process 1100 of FIG. 11 may additionally and/or alternatively be used to identify, for example, a duration of time that a website was displayed, a duration of time that a particular interface within the application was displayed, etc. using the same general method(s) disclosed herein. The process 1100 of FIG. 11 begins when the monitoring data receiver 310 receives a plurality (e.g., two or more, etc.) of screenshots associated with a panelist. (block 1105). The duration identifier 335 identifies a first application used in association with a first screenshot (block 1110). In the illustrated example, the duration identifier 335 identifies the first application based on additional data received from the mobile device 130 such as, for example, an identifier of the application displayed in the foreground of the mobile device 130 at the time of the screenshot. However, any other method of identifying the first application may additionally or alternatively be used such as, for example, using the image processing engine 330 to identify the first application. The duration identifier 335 identifies a first timestamp of the first screenshot (block 1115). In the illustrated example, the first timestamp represents a time at which the first screenshot was captured by the on-device meter 132.

The duration identifier 335 identifies a second application used in association with a second screenshot (block 1120). In the illustrated example, the second screenshot represents the next time-wise (e.g., chronologically ordered) sequential screenshot associated with the panelist. Similar to the first screenshot, the duration identifier 335 identifies the second application based on the additional data received from the mobile device 130. However, any other method of identifying the second application may additionally or alternatively be used. The duration identifier 335 identifies a second timestamp of the second screenshot (block 1125). In the illustrated example, the second timestamp represents a time at which the second screenshot was captured by the on-device meter 132.

The duration identifier 335 determines if the first application is the same as the second application (block 1130). Because the screenshots are chronologically ordered, if the first application is the same as the second application, it can be assumed with confidence that within the first timestamp and the second timestamp that the panelist was interacting with the same application. The duration identifier 335 determines a duration of time between the first timestamp and the second timestamp. (block 1135). In the illustrated example, determining the duration is performed by subtracting the first timestamp from the second timestamp. The duration identifier 335 then credits the panelist with using the identified application (e.g., the first application and/or the second application) for the duration of time. (block 1140). On the contrary, if the first application is different than the second application, the duration identifier 335 does not determine the duration and/or credit the panelist with using the application.

The duration identifier 335 then determines if there is an additional screenshot to be processed (block 1145). If an additional screenshot exists to be processed, control proceeds to block 1150 where the duration identifier refers to the second screen shot as the first screenshot. (block 1150). The additional screenshot is then referred to as the second screenshot by the duration identifier 335. (block 1155). That is, the duration identifier 335 advances to the next temporally sequential pair of screenshots. Because the duration identifier 335 previously processed what is now referred to as the first screenshot, the first screenshot is not processed again to identify an application and/or a timestamp associated with the first screenshot. Accordingly, control proceeds to block 1120. However, the duration identifier 335 may instead reprocess what is now referred to as the first screenshot and proceed to block 1110. In the illustrated example, the duration identifier 335 identifies the timestamp of what is now referred to as the second screenshot (previously the additional screenshot), and proceeds to credit the duration as appropriate.

FIG. 12 is a block diagram of an example processor platform 1200 capable of executing the instructions of FIGS. 9, 10 and/or 11 to implement the example on-device meter 132 of FIGS. 1 and/or 2, and/or the example monitoring data collection site 110 of FIGS. 1 and/or 3. The processor platform 1200 can be, for example, a server, a personal computer, a mobile phone (e.g., a cell phone), a personal digital assistant (PDA), an Internet appliance, a personal video recorder, or any other type of computing device.

The processor platform 1200 of the instant example includes a silicon-based processor 1212. For example, the processor 1212 can be implemented by one or more microprocessors or controllers from any desired family or manufacturer.

The processor 1212 includes a local memory 1213 (e.g., a cache) and is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1214, 1216 is controlled by a memory controller.

The processor platform 1200 also includes an interface circuit 1220. The interface circuit 1220 may be implemented by any type of interface standard, such as an Ethernet interface, a universal serial bus (USB), and/or a PCI express interface.

One or more input devices 1222 are connected to the interface circuit 1220. The input device(s) 1222 permit a user to enter data and commands into the processor 1212. The input device(s) can be implemented by, for example, a keyboard, a mouse, a touchscreen, a track-pad, a trackball, isopoint, a camera, a global positioning sensor, and/or a voice recognition system.

One or more output devices 1224 are also connected to the interface circuit 1220. The output devices 1224 can be implemented, for example, by display devices (e.g., a liquid crystal display, a cathode ray tube display (CRT), a printer and/or speakers). The interface circuit 1220, thus, typically includes a graphics driver card.

The interface circuit 1220 also includes a communication device (e.g., the data communicator 250, the monitoring data receiver 310, etc.) such as a modem or network interface card to facilitate exchange of data with external computers via a network 1226 (e.g., an Ethernet connection, a digital subscriber line (DSL), a telephone line, coaxial cable, a cellular telephone system, etc.).

The processor platform 1200 also includes one or more mass storage devices 1228 for storing software and data. Examples of such mass storage devices 1228 include floppy disk drives, hard drive disks, compact disk drives, and digital versatile disk (DVD) drives. The mass storage device 1228 may implement the data store 220 and/or the data store 350.

The coded instructions 1232 of FIGS. 9, 10, and/or 11 may be stored in the mass storage device 1228, in the volatile memory 1214, in the non-volatile memory 1216, and/or on a removable storage medium such as a CD or DVD.

Although certain example methods, apparatus, and articles of manufacture have been described herein, the scope of coverage of this patent is not limited thereto. On the contrary, this patent covers all methods, apparatus, and articles of manufacture fairly falling within the scope of the claims of this patent.

What is claimed is:

1. A method to identify usage of mobile devices, the method comprising:
processing an image received from a mobile device of a panelist to identify text within the image, the image representing a display of the mobile device;
identifying a first interface displayed by the mobile device based on the identified text; and
crediting the panelist associated with the mobile device as having viewed the identified interface.

2. The method as disclosed in claim 1, further comprising crediting a demographic of the panelist as having viewed the identified interface.

3. The method as described in claim 1, wherein the first interface is an interface of a social media application.

4. The method as described in claim 1, further comprising:
determining whether the identified text can be used to identify a website; and
crediting the panelist associated with the mobile device with having viewed the website when the identified text can be used to identify the website.

5. The method as described in claim 4, wherein the identified text is a universal resource locator.

6. The method as described in claim 1, further comprising:
identifying a barcode within the image; and
crediting the panelist associated with the mobile device with having viewed a product identified by the barcode.

7. The method as described in claim 1, further comprising:
identifying a feature within the image, the feature being indicative of a location of the mobile device; and
crediting the panelist associated with the mobile device with having been at the location of the mobile device.

8. The method as described in claim 7, wherein the feature is a geographic landmark.

9. The method as described in claim 1, wherein the first image represents the display of the mobile device at a first time, and further comprising:
processing a second image received from the mobile device to identify second text within the second image, the second image representing the display of the mobile device at a second time;
identifying, with the processor, a second interface displayed by the mobile device based on the second text;
determining whether the second interface is the first interface; and
crediting the panelist as having viewed the first interface for a duration of time, the duration of time representing a difference between the first time and the second time.

10. An apparatus to identify usage of mobile devices, the apparatus comprising:
a monitoring data receiver to receive an image from a mobile device, the image representing a display of a mobile device;
an optical character recognition (OCR) engine to identify text within the image, the OCR engine to identify an interface displayed by the mobile device based on the identified text; and
a data storer to store an association of the identified interface with a panelist.

11. The apparatus as described in claim 10, further comprising an image processing engine to identify indicia within the image representative of the interface, the image processing engine to identify the interface displayed by the mobile device based on the identified indicia.

12. The apparatus as described in claim 11, wherein:
the image processing engine is to identify a barcode within the image; and
the data storer is to store an association of a product identified by the barcode and the panelist.

13. The apparatus as described in claim 11, wherein the monitoring data receiver is to receive a second image from the mobile device, the second image representing a sequentially captured image of the display of the mobile device, the apparatus further comprising a duration identifier to determine whether the second image represents a same interface as the first image, the duration identifier to credit the panelist as having viewed the interface for a duration of time, the duration of time representing a difference between a first timestamp associated with the first image and a second timestamp associated with the second image.

14. A tangible machine-readable storage medium comprising instructions which, when executed, cause a machine to at least:
process an image received from a mobile device to identify text within the image, the image representing a display of the mobile device;
identify a first interface displayed by the mobile device based on the identified text; and
credit the panelist associated with the mobile device with having viewed the interface when the identified text can be used to identify the interface.

15. The machine-readable medium as disclosed in claim 14, wherein the instructions, when executed, further cause the apparatus further comprising crediting a demographic of the panelist as having viewed the identified interface.

16. The machine-readable medium as described in claim 14, wherein the first interface is an interface of a social media application.

17. The machine-readable medium as described in claim 14, further comprising instructions which, when executed, cause the machine to at least:
determine whether the identified text can be used to identify a website; and
credit a panelist associated with the mobile device with having viewed the website when the identified text can be used to identify the website.

18. The machine-readable medium as described in claim 17, wherein the identified text is a universal resource locator.

19. The machine-readable medium as described in claim 14, further comprising instructions which, when executed, cause the machine to at least:
identify a barcode within the image; and
credit the panelist associated with the mobile device with having viewed a product identified by the barcode.

20. The machine-readable medium as described in claim 14, further comprising instructions which, when executed, cause the machine to at least:
identify a feature within the image, the feature being indicative of a location of the mobile device; and
credit the panelist associated with the mobile device with having been at the location of the mobile device.

21. The machine-readable medium as described in claim 18, wherein the feature is a geographic landmark.

22. The machine-readable medium as described in claim 14, wherein the image is a first image representing the display of the mobile device at a first time, and further comprising instructions which, when executed, cause the machine to at least:
process a second image received from the mobile device to identify second text within the second image, the second image representing the display of the mobile device at a second time;
determine whether the identified second text can be used to identify a second interface;
determine whether the second interface is the first interface;
credit the panelist with having viewed the first interface for a duration of time, the duration of time representing a difference between the first time and the second time.
